(19) United States
(12) Patent Application Publication
(10) Pub. No.: US 2025/0378567 A1
(43) Pub. Date: Dec. 11, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Miki WAKUI, Kanagawa (JP)

(21) Appl. No.: 19/225,024

(22) Filed: Jun. 2, 2025

(30) Foreign Application Priority Data
Jun. 7, 2024 (JP) 2024-092979

(51) Int. Cl. G06T 7/55; G06T 5/50; G06T 7/90; H04N 13/111

(52) U.S. Cl. CPC G06T 7/55; G06T 5/50; G06T 7/90; G06T 2207/10024; G06T 2207/20081; H04N 13/111

(57) ABSTRACT

Even in a case where an object has a gloss characteristic on a surface, a three-dimensional field relating to the object is estimated with high accuracy. An image processing apparatus according to the present disclosure obtains a plurality of captured images which is obtained by capturing an object from each of a plurality of image capturing viewpoints and a camera parameter corresponding to image capturing from each of the plurality of image capturing viewpoints, generates a plurality of low gloss images in which a gloss component of the object is reduced based on the plurality of captured images; and performs learning of a learning model indicating a three-dimensional field relating to the object by using the plurality of low gloss images and the plurality of captured images and the camera parameter.

### BACKGROUND

### Field

The present disclosure relates to a technique of estimating a three-dimensional field based on a plurality of captured images which is obtained by image capturing from various positions and directions.

### Description of the Related Art

There is a technique of estimating a three-dimensional field relating to an object by using a plurality of captured images (hereinafter referred to as “multi-viewpoint images”) which is obtained by capturing the object to be captured (hereinafter simply referred to as “object”) from various positions and directions. “NeRF: Representing Scenes as Neural Radiance Fields for View Synthesis” (hereinafter referred to as “non-patent document 1”) discloses a technique of estimating radiance fields relating to an object, called NeRF (Neural Radiance Fields), as a technique of estimating a three-dimensional field relating to an object by using multi-viewpoint images.

In the NeRF, learning of a neural network to output a color and density (hereinafter simply referred to as “neural network”) is performed with respect to any position and any direction in a space captured from various positions and directions (hereinafter referred to as “image capturing space”). As a result of the learning, a learned neural network indicating the radiance fields relating to the object present in the image capturing space is obtained. By volume rendering using the learned neural network, a virtual viewpoint image corresponding to appearance in a case where the image capturing space is viewed from an arbitrary virtual viewpoint (hereinafter referred to as “virtual viewpoint”) can be generated. Hereinafter, a position at which the image capturing space is captured is described as “image capturing position” and explained.

In the learning of the neural network in the NeRF, first, any position on a ray corresponding to each pixel in each of the plurality of captured images constituting the multi-viewpoint image (hereinafter simply referred to as “ray”) is set as a sampling point. Next, in the neural network in the middle of the learning, a color and the density in the sampling point are estimated and output based on the pixel value of the captured image corresponding to each image capturing position. Subsequently, the colors of a plurality of sampling points on an identical ray are accumulated according to the density, and volume rendering is thereby performed, and the estimation value of a pixel corresponding to the ray in an image is calculated. Then, a difference between the calculated estimation value and the value (pixel value) of the corresponding pixel in the captured image corresponding to the image is calculated as a loss by a loss function. Finally, a network parameter of the neural network is updated by error backpropagation based on the loss calculated by the loss function, and thereby the learning of the neural network is performed. According to the NeRF, the three-dimensional shape, gloss, and transparency of the object can be reproduced by estimating the three-dimensional field relating to the object present in the image capturing space as a radiance field.

### SUMMARY

In a case where the surface of an object is glossy, because of the reflection of light in the surface of the object, the pixel value of the captured image corresponding to each of a plurality of rays in which the sampling points at the same position are set may be significantly different. In such a case, in the technique described in non-patent document 1, there is a problem that because of the occurrence of an error in learning of transmittance in the sampling points, a three-dimensional field is estimated as if the surface of the object is at a position which is significantly different from an original position. For example, in a case where it is estimated that the surface of the object is on an inner side of the original position of the surface of the object with respect to the object, in the three-dimensional field relating to the object, an indentation arises at a position corresponding to the surface of the object. Conversely, in a case where it is estimated that the surface of the object is on an outer side of the original position of the surface of the object with respect to the object, in the three-dimensional field relating to the object, an artifact such as a cluster called a floater arises near the position corresponding to the surface of the object.

An image processing apparatus obtains a plurality of captured images which is obtained by capturing an object from each of a plurality of image capturing viewpoints, obtains a camera parameter corresponding to image capturing from each of the plurality of image capturing viewpoints, generates plurality of low gloss images in which a gloss component of the object is reduced based on the plurality of captured images and performs learning of a learning model indicating a three-dimensional field relating to the object by using the plurality of low gloss images and the plurality of captured images and the camera parameter.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an image capturing system in accordance with Embodiment 1;

FIG. 2 is a block diagram illustrating an example of a hardware configuration of an image processing apparatus in accordance with Embodiment 1;

FIG. 3 is a block diagram illustrating an example of a functional configuration of the image processing apparatus in accordance with Embodiment 1;

FIG. 4 is a flow chart illustrating an example of a process flow in the image processing apparatus in accordance with Embodiment 1;

FIG. 5 is a flow chart illustrating an example of a flow of a process of generating a low gloss image in a first generation unit in accordance with Embodiment 1;

FIGS. 6A to 6D are diagrams to describe an example of the process of generating the low gloss image in the first generation unit in accordance with Embodiment 1;

FIGS. 7A and 7B are diagrams to describe an example of the process of generating the low gloss image in the first generation unit in accordance with Embodiment 1;

FIG. 8 is a flow chart illustrating an example of a flow of a first learning process in a learning unit in accordance with Embodiment 1;

FIG. 9 is a diagram illustrating an example of a ray and a sampling point in accordance with Embodiment 1;

FIG. 10 is a flow chart illustrating an example of a flow of a second learning process in the learning unit in accordance with Embodiment 1;

FIG. 11 is a flow chart illustrating an example of a process flow in an image processing apparatus in accordance with Embodiment 2;

FIG. 12 is a flow chart illustrating an example of a flow of a process of generating a low gross image in a first generation unit in accordance with Embodiment 2;

FIG. 13 is a diagram to describe an example of a method for determining the pixel value of the low gloss image in accordance with Embodiment 2;

FIG. 14 is a flow chart illustrating an example of a process flow in an image processing apparatus in accordance with Embodiment 3;

FIG. 15 is a flow chart illustrating an example of a flow of a second learning process in a learning unit in accordance with Embodiment 3; and

FIGS. 16A and 16B are diagrams to describe an example of a method for determining a setting range of a sampling point in accordance with Embodiment 3.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made. Further, an explanation about each step in the flow charts mentioned below is made by using a reference symbol starting with “S.”

### Embodiment 1

### <Configuration of an Image Capturing System>

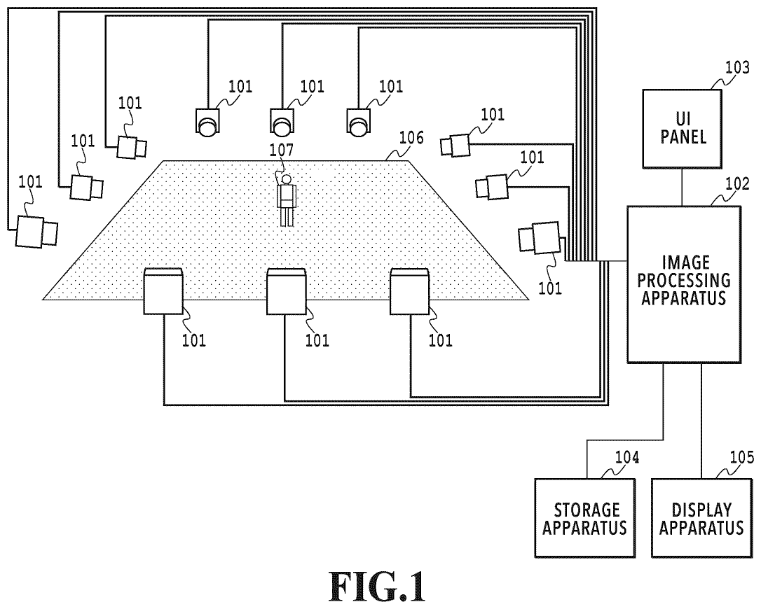

FIG. 1 is a diagram illustrating an example of a configuration of an image capturing system in accordance with Embodiment 1. The image capturing system has a plurality of image capturing apparatuses 101, an image processing apparatus 102, a user interface (hereinafter “UI”) panel 103, a storage apparatus 104, and a display apparatus 105. Each image capturing apparatus 101 is composed of a digital still camera or a digital video camera or the like and is arranged in a different position. Each image capturing apparatus 101 generates a piece of data on a captured image corresponding to each viewpoint (hereinafter referred to as “captured image data”) by capturing an image of an object 107 present in an image capturing space 106 according to an image capturing condition from a different viewpoint in synchronization with each other.

Incidentally, the image capturing in synchronization with each other does not mean the same time, but means image capturing on performing a synchronization process. In other words, the image capturing in synchronization with each other does not have to be performed at exactly the same time, but a case where the image capturing in synchronization with each other is performed at almost the same time is included. The piece of captured image data which is obtained by the image capturing performed by the image capturing apparatus 101 may be a piece of still image data or a piece of moving image data, or both the piece of still image data and the piece of moving image data. Hereinafter, an explanation is made on the premise that the wording “image” has both meanings of “still image” and “moving image” unless otherwise specified. The piece of captured image data generated by each image capturing apparatus 101 is transmitted to the image processing apparatus 102.

The image processing apparatus 102 obtains a piece of data on a plurality of captured images (multi-viewpoint images) transmitted from the plurality of image capturing apparatuses 101 and performs learning of a three-dimensional field relating to a space including the object 107 present in the image capturing space 106 by using the obtained multi-viewpoint images. Information or a signal indicating a learned three-dimensional field which is obtained as a result of the learning performed by the image processing apparatus 102 is output to the storage apparatus 104 or the display apparatus 105 or the like. The image processing apparatus 102 may generate a virtual viewpoint image based on the learned three-dimensional field which is obtained as a result of the learning. In this case, for example, a piece of data or a signal on the virtual viewpoint image generated by the image processing apparatus 102 is output to the storage apparatus 104 or the display apparatus 105 or the like.

Incidentally, in the present embodiment, as illustrated in FIG. 1, an explanation is made on the premise that each of the plurality of image capturing apparatuses 101 is mutually connected to the image processing apparatus 102, but a method for performing connection between the plurality of image capturing apparatuses 101 and the image processing apparatus 102 is not limited to this. Specifically, for example, the plurality of image capturing apparatuses 101 are cascaded by connecting adjacent image capturing apparatuses 101 to each other, and at least one of the plurality of image capturing apparatuses 101 may be connected to the image processing apparatus 102.

Further, in the present embodiment, as illustrated in FIG. 1 as an example, an explanation is made based on the premise that the plurality of image capturing apparatuses 101 are arranged in mutually different positions, but the number and the arrangement of the image capturing apparatuses 101 are not limited to this. For example, in a case where the position, shape, and color of the object 107 present in the image capturing space 106 and the intensity or tint or the like of ambient light do not temporally change, at least one image capturing apparatus 101 whose position and orientation may be changed may be arranged. In this case, while the position and orientation of the image capturing apparatus 101 are changed, the image capturing apparatus 101 is made to perform image capturing in each of a plurality of positions different from each other and the image processing apparatus 102 may obtain a plurality of pieces of captured image data which is obtained by the image capturing as a piece of multi-viewpoint image data.

The UI panel 103 includes a display device such as a liquid crystal panel and displays a GUI (graphical user interface) to present the image capturing condition in the image capturing apparatus 101 and information such as a process setting of the image processing apparatus 102 to a user on the display device. Further, the UI panel 103 may include an input device such as a touch panel or a button, and in this case, the UI panel 103 receives an instruction from a user via the input device in relation to a change or the like in the above image capturing condition or the process setting or the like. Like a mouse or a keyboard or the like, the input device may be provided separately from the UI panel 103.

The storage apparatus 104 is composed of a hard disk drive or the like, obtains information indicating the three-dimensional field relating to the object 107 output from the image processing apparatus 102, and stores the obtained information. Further, in a case where the image processing apparatus 102 generates the virtual viewpoint image, the storage apparatus 104 may obtain the piece of data on the virtual viewpoint image output from the image processing apparatus 102 and store the piece of obtained virtual viewpoint image data.

The display apparatus 105 is composed of a liquid crystal display or the like, obtains a signal of a display image including an image indicating the three-dimensional field relating to the object 107 output from the image processing apparatus 102, and displays the display image corresponding to the signal. Further, in a case where the image processing apparatus 102 generates the virtual viewpoint image, the display apparatus 105 may obtain the signal of the display image including the virtual viewpoint image output from the image processing apparatus 102 and display the display image corresponding to the signal.

The image capturing space 106 is a three-dimensional space surrounded by the plurality of image capturing apparatuses 101 installed in a studio or the like, and a frame illustrated in a solid line in FIG. 1 indicates an outline of the image capturing space 106 in a floor surface. Hereinafter, as an example, an aspect in which 12 image capturing apparatuses 101 installed in the studio are used to capture one or more objects 107 from the surroundings thereof is explained.

### <Hardware Configuration of the Image Processing Apparatus>

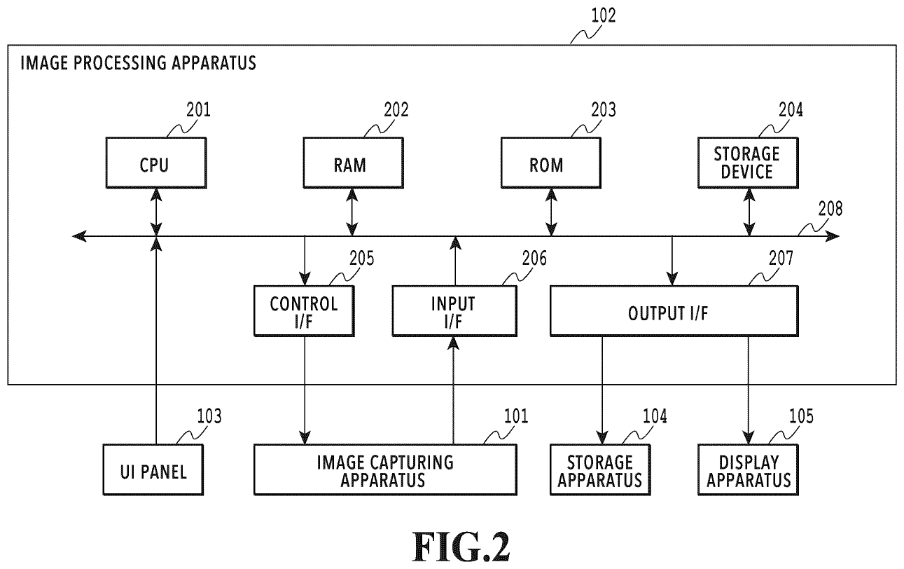

FIG. 2 is a block diagram illustrating an example of a hardware configuration of the image processing apparatus 102 in accordance with Embodiment 1. The image processing apparatus 102 has, as the hardware configuration, a CPU 201, a RAM 202, a ROM 203, a storage device 204, a control interface (hereinafter “I/F”) 205, an input I/F 206, an output I/F 207, and a main bus 208.

The CPU 201 is a processor totally controlling each unit of the image processing apparatus 102. The CPU 201 executes an OS (operating system) stored in the ROM 203 or the storage device 204 or the like and various kinds of programs by using the RAM 202 as work memory. The CPU 201 controls the entire image processing apparatus 102 via the main bus 208 by executing the various kinds of programs. Incidentally, a process of each step illustrated in a flow chart described below is realized as a result of a program code stored in the ROM 203 or the storage device 204 or the like being developed into the RAM 202 and the CPU 201 executing this. The RAM 202 functions as main memory and a work area or the like of the CPU 201. The ROM 203 stores a group of programs to be executed by the CPU 201. The storage device 204 is composed of a hard disc drive or the like and stores an application program to be executed by the CPU 201 and various kinds of data or the like to be used for a process of the CPU 201.

The control I/F 205 is connected to each of the plurality of image capturing apparatuses 101 and is a communication interface to perform control such as the setting of an image capturing condition, a start of image capturing, and a stop of the image capturing on each image capturing apparatus 101. The input I/F 206 is a communication interface to perform communication with a serial bus or the like such as an SDI (Serial Digital Interface) or HDMI® (High-Definition Multimedia Interface®). A piece of captured image data output from each image capturing apparatus 101 is obtained via the input I/F 206. The output I/F 207 is a communication interface to perform communication with a serial bus or the like such as a USB (Universal Serial Bus) or a DisplayPort®. The piece of data or the signal on the three-dimensional field and the virtual viewpoint image is output to the storage apparatus 104 or the display apparatus 105 via the output I/F 207. The main bus 208 is a transmission line mutually communicably connecting each hardware configuration which is mentioned above and which the image processing apparatus 102 has.

### <Functional Configuration of the Image Processing Apparatus>

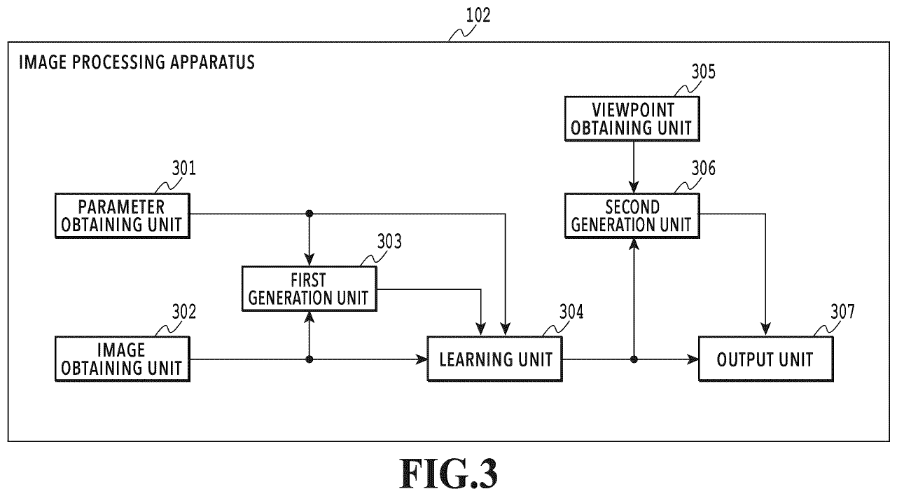

FIG. 3 is a block diagram illustrating an example of a functional configuration of the image processing apparatus 102 in accordance with Embodiment 1. The image processing apparatus 102 has, as the functional configuration, a parameter obtaining unit 301, an image obtaining unit 302, a first generation unit 303, a learning unit 304, a viewpoint obtaining unit 305, a second generation unit 306, and an output unit 307. Each unit which the image processing apparatus 102 has as the functional configuration is realized as a result of the CPU 201 executing the program stored in the ROM 203 or the like by using the RAM 202 as work memory. Incidentally, not all the processes described below have to be always realized as a result of the CPU 201 executing the program, and the image processing apparatus 102 may be configured so that part or all of the processes are executed by one or more process circuits other than the CPU 201.

The parameter obtaining unit 301 obtains a camera parameter of each image capturing apparatus 101. The camera parameter of each image capturing apparatus 101 is described on the premise that the camera parameter of each image capturing apparatus 101 is stored in the storage device 204 in advance. However, the camera parameter of each image capturing apparatus 101 may be estimated by the image processing apparatus 102 by using the piece of captured image data. In this case, for example, the image processing apparatus 102 estimates the camera parameter of each image capturing apparatus 101 by using an algorithm in which the shape of the object 107 is estimated while an image capturing position is estimated based on the captured image called COLMAP which is well-known in the technical fields of NeRF or the like. The camera parameter includes an intrinsic parameter, an extrinsic parameter, and a distortion parameter or the like.

The intrinsic parameter is a parameter representing the coordinates of the center of the captured image which is obtained by the image capturing performed by the image capturing apparatus and a focal length of a lens which the image capturing apparatus has. Further, the extrinsic parameter is a parameter representing the position and orientation of the image capturing apparatus, and the distortion parameter is a parameter indicating the distortion of the lens. Incidentally, the plurality of image capturing apparatuses 101 does not have to use common camera parameters, and in particular, does not have to use the common intrinsic parameter or the common distortion parameters, and for example, the viewing angles of part of the image capturing apparatuses 101 may be different from the viewing angles of other image capturing apparatuses 101. A camera parameter obtained by a parameter obtaining unit 301 is transmitted to the first generation unit 303 and the learning unit 304.

The image obtaining unit 302 obtains the piece of captured image data which is obtained by the image capturing performed by each image capturing apparatus 101. A source from which the piece of captured image data is obtained is not limited to the image capturing apparatus 101, and the image obtaining unit 302 may obtain the piece of captured image data by reading the piece of captured image data out from the storage device 204 or the storage apparatus 104 or the like. Further, the image obtaining unit 302 obtains a piece of data on a background image corresponding to the captured image captured by each image capturing apparatus 101 (hereinafter referred to as “background image data”). The background image is an image captured by using a camera parameter used for capturing of the corresponding captured image and, for example, an image which is obtained by the following image capturing.

For example, the background image is an image which is obtained by in advance capturing an object such as a ground or a structure or the like other than the object 107 which object is expected to be reflected in a case where the object 107 is captured in a state where the object 107 does not exist. For example, the piece of background image data is stored in the storage device 204 or the storage apparatus 104 or the like in advance, and the image obtaining unit 302 obtains the piece of background image data by reading out the piece of background image data from the storage device 204 or the like. The piece of captured image data obtained by the image obtaining unit 302 is transmitted to the first generation unit 303 and the learning unit 304, and the piece of background image data is transmitted to the first generation unit 303.

The first generation unit 303 generates an image in which a gloss component of the object 107 is reduced (hereinafter referred to as “low gross image”) based on the piece of captured image data and the piece of background image data transmitted from the image obtaining unit 302. Details on a process of generating the low gloss image using the piece of captured image data and the piece of background image data in the first generation unit 303 are described later in the present embodiment. Further, for example, the image obtaining unit 302 may generate the low gloss image by using the piece of captured image data and the piece of background image data transmitted from the image obtaining unit 302 and the camera parameter transmitted from the parameter obtaining unit 301. Details on the process of generating the low gloss image using the piece of captured image data, the piece of background image data, and the camera parameter in the first generation unit 303 are described in Embodiment 2. A piece of data on the low gloss image generated by the first generation unit 303 (hereinafter referred to as “low gloss image data”) is transmitted to the learning unit 304.

The learning unit 304 estimates the three-dimensional field relating to the object 107 by performing a learning process in which the piece of captured image data transmitted from the image obtaining unit 302 and the piece of low gloss image data transmitted from the first generation unit 303 are pieces of ground truth data. In the present embodiment, an explanation is made on the premise that the learning unit 304 estimates a radiance field represented by the color and the density of the learning space set in the image capturing space 106 as the three-dimensional field relating to the object 107. The radiance field is represented by using equation (1), for example.

$${F}_{θ} ( x , y , z , θ , ϕ ) \to ( R , G , B , o ) \qquad equation ( 1 )$$

F_{θ} is a function which outputs a color (R, G, B) and density σ in the three-dimensional coordinates (x, y, z) in a case where the three-dimensional coordinates (x, y, z) in the set learning space and a direction (θ, Φ) in the learning space are input. In the present embodiment, in relation to a learning model (hereinafter referred to as “three-dimensional field learning model”) in which the Fe is realized by a multilayer perceptron (MLP), an explanation is made on the premise that a radiance field is estimated as a result of the learning unit 304 performing learning by deep learning. In other words, in the present embodiment, as an example, an aspect in which a learning process in which the piece of captured image data and the piece of low gloss image data are the pieces of ground truth data is performed on the three-dimensional learning model is described. Therefore, in the present embodiment, the result of the estimation of the three dimensional field (radiance field) relating to the object 107 is obtained as a learned three-dimensional field learning model (hereinafter referred to as “three-dimensional field learned model”). Information on the three-dimensional field learned model which is obtained as the result of the estimation of the three-dimensional field (radiance field) relating to the object 107 is transmitted to the second generation unit 306 and the output unit 307.

A viewpoint obtaining unit 305 obtains virtual viewpoint information including at least information indicating the position of the virtual viewpoint and information indicating a viewing direction in the virtual viewpoint (hereinafter referred to as “virtual viewpoint direction”). For example, information or the like indicating the position and the direction of the virtual viewpoint is given as a result of a user providing input by using a GUI (not illustrated) displayed on the UI panel 103. The virtual viewpoint information obtained by the virtual viewpoint obtaining unit 305 is transmitted to the second generation unit 306.

The second generation unit 306 generates the virtual viewpoint image by using the three-dimensional field learned model transmitted from the learning unit 304 and the virtual viewpoint information transmitted from the viewpoint obtaining unit 305. Specifically, the second generation unit 306 generates the virtual viewpoint image corresponding to the virtual viewpoint information by inputting the virtual viewpoint information to the three-dimensional field learned model and setting a pixel value output from the three-dimensional field learned model as the pixel value of the virtual viewpoint image. A piece of data on the virtual viewpoint image generated by the second generation unit 306 is transmitted to the output unit 307.

The output unit 307 outputs the three-dimensional field learned model transmitted from the learning unit 304. Specifically, for example, the output unit 307 outputs a piece of data on the three-dimensional field learned model to the storage apparatus 104 and makes the storage apparatus 104 store the piece of data on the three-dimensional field learned model. The output unit 307 may display the three-dimensional field as a display image on the display apparatus 105 by converting the three-dimensional field indicated by the three-dimensional field learned model into a display image signal and outputting the display image signal to the display apparatus 105. Further, the output unit 307 outputs the virtual viewpoint image transmitted from the second generation unit 206. For example, the output unit 307 outputs the piece of data on the virtual viewpoint image to the storage apparatus 104 and makes the storage apparatus 104 store the piece of data on the virtual viewpoint image. The output unit 307 may display the virtual viewpoint image on the display apparatus 105 by converting the virtual viewpoint image into the display image signal and outputting the display image signal to the display apparatus 105.

### <Operation of the Image Processing Apparatus>

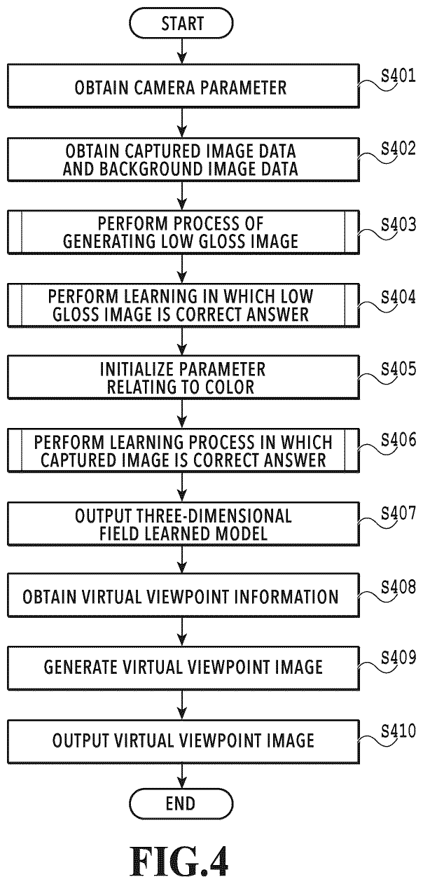

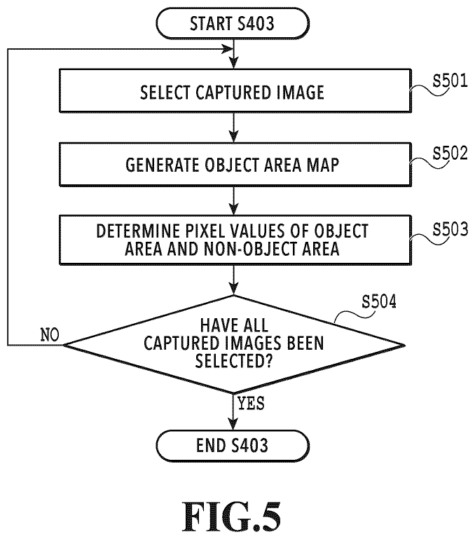

FIG. 4 is a flow chart illustrating an example of a process flow in the image processing apparatus 102 in accordance with Embodiment 1. With reference to FIG. 4, an operation of the image processing apparatus 102 is described. First, in S401, the parameter obtaining unit 301 obtains a camera parameter of each image capturing apparatus 101. Next, in S402, the image obtaining unit 302 obtains the piece of captured image data which is obtained by the image capturing performed by each image capturing apparatus 101 and the piece of background image data corresponding to each piece of captured image data. Subsequently, in S403, the first generation unit 303 generates the low gloss image. Specifically, first, the first generation unit 303 extracts an image area including a representation of the object 107 (hereinafter referred to as “object area”) from each captured image obtained in S402 by using the piece of background image data obtained in S402. Next, the first generation unit 303 performs the process of generating the low gloss image based on the extracted object area. A specific process in S403 is described below by using FIG. 5.

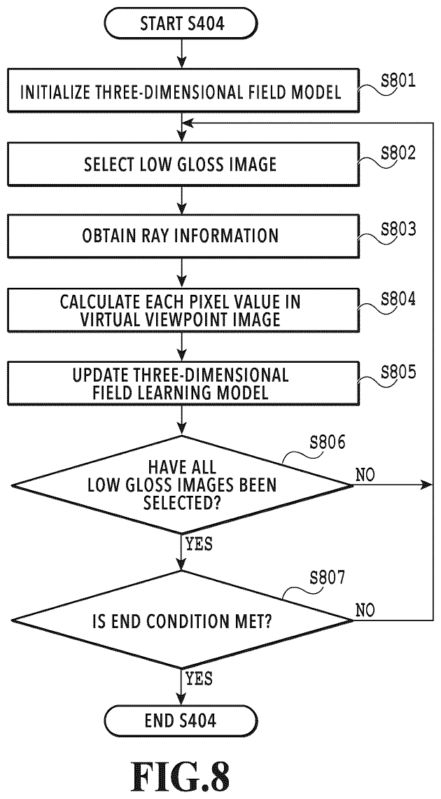

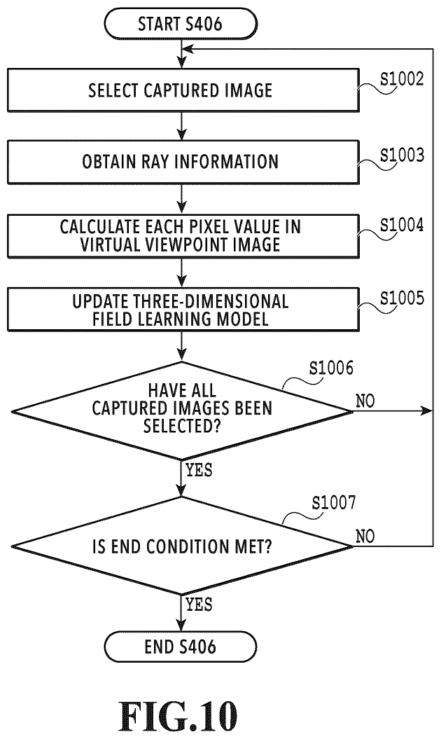

After S403, in S404, the learning unit 304 performs a learning (hereinafter referred to as “first learning”) process in which the low gloss image data generated in S403 is a piece of ground truth data on the three-dimensional field learning model. A specific process in S404 is described below by using FIG. 8. Next, in S405, the learning unit 304 initializes a parameter relating to a color among parameters in the three-dimensional field learning model which are obtained as a result of the first learning process in S404. Subsequently, in S406, the learning unit 304 performs a learning (hereinafter referred to as “second learning”) process in which the piece of captured image data obtained by the image capturing performed by each image capturing apparatus 101 is a piece of ground truth data on the initialized three-dimensional learning model in which the parameter relating to the color is initialized in S405. A specific process in S406 is described below by using FIG. 10.

After S406, in S407, the output unit 307 outputs the three-dimensional field learned model which is obtained as a result of the second learning process in S406. Next, in S408, the viewpoint obtaining unit 305 obtains the virtual viewpoint information. Subsequently, in S409, the second generation unit 306 generates the virtual viewpoint image based on the three-dimensional field learned model which is obtained as a result of the second learning process in S406 and the virtual viewpoint information obtained in S408. Then, in S410, the output unit 307 outputs the virtual viewpoint image generated in S408. After S410, the image processing apparatus 102 ends the processes of the flow chart illustrated in FIG. 4.

The image processing apparatus 102 repeatedly performs the processes of the flow chart illustrated in FIG. 4 every time the image processing apparatus 102 receives a new piece of captured image data from each image capturing apparatus 101 or the like. Further, in a case where the piece of captured image data obtained in S402 is a piece of moving image data, for example, the image processing apparatus 102 repeatedly performs the processes of the flow chart illustrated in FIG. 4 every time the image processing apparatus 102 receives a piece of new frame data constituting the moving image from each image capturing apparatus 101 or the like. In this case, as long as the camera parameter of each image capturing apparatus 101 is not changed, the process in S401 may be omitted. Furthermore, similarly, in this case, the obtainment of the piece of background image data in S402 may be omitted.

### <Process of Generating the Low Gloss Image>

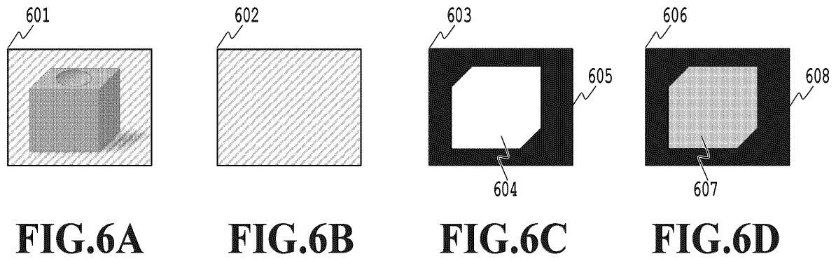

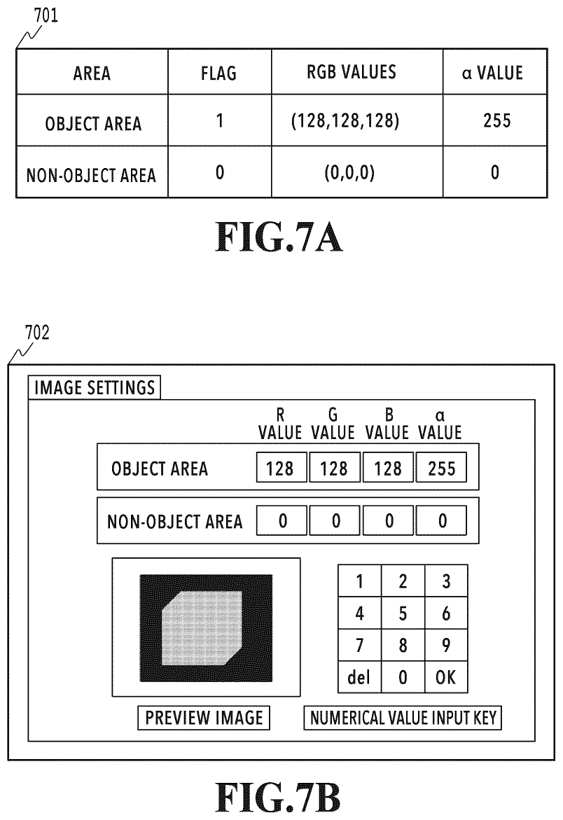

With reference to FIGS. 5 to 7B, a process of generating the low gross image in S403 performed by the first generation unit 303 is described. FIG. 5 is a flow chart illustrating an example of a flow of the process of generating the low gloss image in the first generation unit 303 in accordance with Embodiment 1. FIGS. 6A to 6D and FIGS. 7A and 7B are diagrams to describe an example of the process of generating the low gloss image in the first generation unit 303 in accordance with Embodiment 1. Specifically, FIG. 6A illustrates an example of a captured image 601 and FIG. 6B illustrates an example of a background image 602 corresponding to the captured image 601. Further, FIG. 6C illustrates an example of an object area map 603 corresponding to the captured image 601 and FIG. 6D illustrates an example of a low gloss image 606 corresponding to the captured image 601. FIG. 7A illustrates an example of the set value of a pixel value in the low gloss image 606 and FIG. 7B illustrates an example of a GUI 702 to set the pixel value in the low gloss image 606.

The process of the flow chart illustrated in FIG. 5 is performed after the process in S402 illustrated in FIG. 4. After S402, first, in S501, the first generation unit 303 selects a piece of data on any captured image (for example, the captured image 601) from a plurality of pieces of captured image data obtained in S402. Next, in S502, the first generation unit 303 generates the object area map 603 based on a difference between the captured image 601 selected in S501 and the background image 602 corresponding to the captured image 601 of a plurality of background images obtained in S402. Specifically, the first generation unit 303 first extracts an object area in the captured image 601 based on the difference. Next, the first generation unit 303 generates the object area map 603 indicating the position of the extracted object area 604 and the position of a non-object area 605 indicating an area other than the object area, that is, a background area. For example, the first generation unit 303 determines that a pixel in which a difference between the captured image 601 and the background image 602 is equal to or greater than a predetermined threshold value is a pixel included in the object area 604. Further, the first generation unit 303 generates the object area map 603 by determining that a pixel in which the difference is less than the predetermined threshold value is the pixel included in the non-object area 605.

Incidentally, in the present embodiment, an explanation is made on the premise that the object area in the captured image 601 is extracted based on the difference between the captured image 601 and the background image 602, but a method for extracting the object area in the captured image 601 is not limited to this. For example, the first generation unit 303 may extract the object area in the captured image 601 by using the learned model which is obtained as a result of learning such as machine learning or the like. Specifically, for example, the first generation unit 303 first inputs the captured image 601 to the learned model which outputs information indicating the position of an area of a representation of a predetermined object included in an input image. Next, the first generation unit 303 extracts an area as an object area by obtaining information indicating the position of the area of a representation of the object 107 included in the captured image 601 output from the learned model.

After S502, in S503, the first generation unit 303 determines the pixel value of an area 607 corresponding to the object area 604 and the pixel value of an area 608 corresponding to the non-object area 605 in the object area map 603 in the low gloss image 606. For example, the pixel values of the areas 607 and 608 in the low gloss image 606 are determined based on a value input by the user by using the GUI 702 illustrated in FIG. 7B as an example. Incidentally, the GUI 702 is displayed on a display device or the like of the UI panel 103. Pixel values such as an R (Red) value, a G (Green) value, and a B (Blue) value, and an a value indicating the degree of transparency of a pixel which are input in the GUI 702 are held in the storage device 204 in, for example, a form as in a table 701 illustrated in FIG. 7A as an example. In other words, the first generation unit 303 refers to the table 701 held in the storage device 204 or the like and thereby determines the pixel values of the areas 607 and 608 in the low gloss image 606. The low gloss image 606 corresponding to the captured image 601 is generated by the process in S503.

Incidentally, in the table 701, a flag indicates in binary whether or not each pixel in the low gloss image 606 is included in the object area 604 in the object area map 603. Further, the RGB values express the values of respective color components of R, G, and B in the pixel in the range of 0 to 255. Further, the a value expresses the degree of transparency of the pixel in the range of 0 to 255, and as the a value becomes larger, the pixel becomes more opaque, and as the a value becomes smaller, the pixel becomes more transparent. Because of the process in S503, the low gloss image 606 corresponding to the captured image 601 is generated.

After S503, in S504, the first generation unit 303 judges in S501 whether all the pieces of captured image data obtained in S402 are selected in S501 or not. In a case where it is judged in S504 that at least part of the pieces of captured image data are not selected, the first generation unit 303 returns to the process in S501 and repeatedly performs the processes from S501 to S504 until it is judged in S504 that all the pieces of captured image data are selected. In the repeated processes, in S501, the first generation unit 303 selects, for example, any piece of captured image data which has not been selected yet. In a case where it is judged in S504 that all the pieces of captured image data are selected, the first generation unit 303 ends the processes in the flow chart illustrated in FIG. 5, namely, the process in S403.

### <First Learning Process>

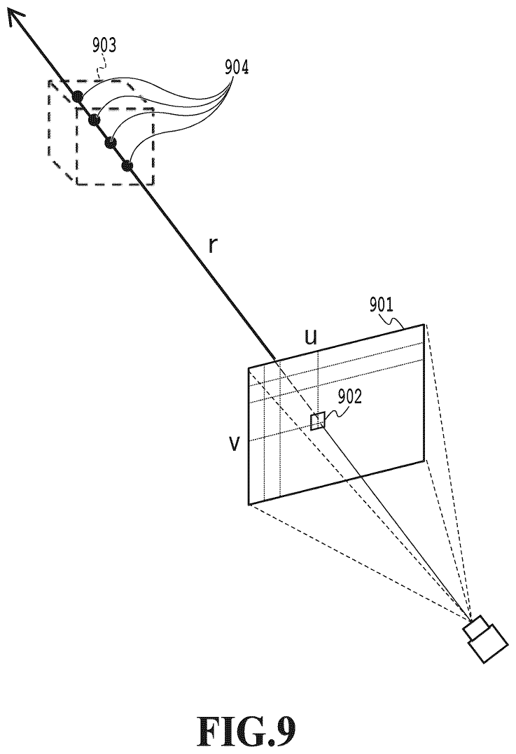

With reference to FIGS. 8 and 9, the first learning process in S404 performed by the learning unit 304 is described. FIG. 8 is a flow chart illustrating an example of a flow of the first learning process in which the piece of low gloss image data in the learning unit 304 in accordance with Embodiment 1 is the piece of ground truth data. The processes in the flow chart illustrated in FIG. 8 are performed after the process in S403 illustrated in FIG. 4. After S403, first, in S801, the learning unit 304 initializes the three-dimensional learning model by setting initial values to parameters and hyper-parameters of the three-dimensional field learning model at. Next, in S802, the learning unit 304 selects any piece of low gloss image data of a plurality of pieces of low gloss image data generated in S403. The piece of low gloss image data selected in S802 is used in the process in S805 mentioned below as a piece of ground truth data in the first learning process.

Next, in S803, the learning unit 304 obtains information on a ray corresponding to each pixel of the low gloss image (hereinafter referred to as “ray information”) based on the camera parameter of the image capturing apparatus 101 which captures the captured image corresponding to the piece of low gloss image data selected in S802. In the present embodiment, the ray information includes information indicating the position of the image capturing apparatus to be a start point of the ray, information indicating the direction of the ray, and information indicating the value (pixel value) of a pixel in the low gloss image corresponding to the ray. The direction of the ray can be represented by using, for example, equation (2) based on the camera parameter and the coordinates of the pixel in the low gloss image.

$$d = ( ( u - {c}_{x} ) / {f}_{x} , ( v - {c}_{y} ) / {f}_{y} , 1 ) \qquad equation ( 2 )$$

Here, d represents a direction vector of the ray, (u, v) represents the coordinates of the pixel in the low gloss image, (cₓ, c_{y}) represents the coordinates of the center in the low gloss image, and (fₓ, f_{y}) represents a focal length of the image capturing apparatus 101.

After S803, in S804, the learning unit 304 performs volume rendering relating to a three-dimensional field learning model in the middle of learning based on the ray information obtained in S803. Each pixel value in the virtual viewpoint image corresponding to appearance from the start point of the ray indicated by the ray information is thereby calculated. Specifically, first, the learning unit 304 sets as many rays as the number of rays used for learning preset by the hyper-parameters or the like based on the ray information. Next, the learning unit 304 sets as many sampling points as the number of sampling points preset by the hyper-parameters or the like on each ray which is set. Subsequently, the learning unit 304 performs volume rendering by accumulating colors estimated in a plurality of sampling points set on each ray according to estimated density. Each pixel value in the virtual viewpoint image in a case where volume rendering is performed based on the ray information is thereby calculated. More specifically, first, the learning unit 304 sets the plurality of sampling points on each ray in the learning space and obtains the estimation values of the colors and the density corresponding to the sampling points based on the position of each sampling point and the direction of the ray. Next, the learning unit 304 calculates the value (pixel value) of the pixel corresponding to the ray in the virtual viewpoint image by using, for example, equation (3) and equation (4).

$$C ( r ) = {\sum }_{i = 1}^{N} {T}_{i} ( 1 - exp ( - {σ}_{i} {δ}_{i} ) ) {c}_{i} \qquad equation ( 3 )$$

$${T}_{i} = exp ( - {\sum }_{j = 1}^{i - 1} {σ}_{j} {δ}_{j} ) \qquad equation ( 4 )$$

Here, C(r) is a pixel value corresponding to a ray r in the virtual viewpoint image, i is an index of a sampling point, oi is density in the sampling point, δᵢ is a distance to a next sampling point, and ci is the value of a color in the sampling point. Incidentally, Ti is accumulated transmittance in each sampling point.

FIG. 9 is a diagram illustrating an example of a ray r and a sampling point 904 in accordance with Embodiment 1. FIG. 9 illustrates an example of the ray r corresponding to a pixel 902 of the coordinates (u, v) in the low gloss image 901 selected in S802. In FIG. 9, a plurality of black points illustrated in a learning space 903 is the sampling points 904 set on the ray r.

After S804, in S805, the learning unit 304 calculates a difference between the value (pixel value) of each pixel in the virtual viewpoint image calculated in S804 and the value (pixel value) of a pixel in the low gloss image corresponding to the pixel and updates the three-dimensional field learning model so that the difference becomes small. In the present embodiment, as an example, the difference is defined as a squared Euclidean distance and is calculated by using a loss function, and a network parameter of the three-dimensional field learning model is updated by using error back propagation. In this way, the learning unit 304 performs the learning (first learning) process of learning the three dimensional field learning model in which the piece of low gloss image data is the piece of ground truth data.

Next, in S806, the learning unit 304 judges in S802 whether all pieces of the low gloss image data are selected or not. In a case where it is judged in S806 that at least part of the pieces of the low gloss image data are not selected, the learning unit 304 returns to the process in S802 and repeatedly performs the processes from S802 to S806 until it is judged in S806 that all the pieces of the low gloss image data are selected. In the repeated processes, the learning unit 304 selects, for example, any piece of low gloss image data which has not been selected yet in S802.

In a case where it is judged in S806 that all pieces of the low gloss image data are selected, the learning unit 304 judges in S807 whether an end condition relating to the first learning process is met or not. Specifically, for example, the learning unit 304 judges whether the end condition relating to the first learning process is met or not by judging whether the first learning has converged or not. For example, the learning unit 304 judges whether the first learning has converged or not by judging whether a loss value calculated from the loss function is equal to or less than a predetermined threshold value or not. Incidentally, a method for judging whether the end condition relating to the first learning process is met or not is not limited to the above, but, for example, whether or not the first learning process is performed for a predetermined period may be judged.

In a case where it is judged in S807 that the end condition relating to the first learning process is not met, the learning unit 304 returns to the process in S802 and repeatedly performs the processes from S802 to S807 until it is judged in S807 that the end condition relating to the first learning process is met. In a case where it is judged in S807 that the end condition relating to the first learning process is met, the learning unit 304 ends the processes in the flow chart illustrated in FIG. 8, namely, the process in S404 illustrated in FIG. 4.

The three-dimensional field learning model after the learning performed by the first learning process in S404 is highly accurate in the density in the three-dimensional field relating to the object 107. On the other hand, in the low gloss image, the color of the object area is a predetermined color which does not depend on a color which the object 107 actually has. Thus, the three-dimensional field learning model after the learning performed by the first learning process in S404 has no meaning to the color in the three-dimensional field relating to the object 107. Accordingly, in the process in S405, a parameter relating to the color in the three-dimensional field learning model is initialized, and in S406, a second learning process to enhance accuracy in the color is performed on the three-dimensional field learning model after the initialization of the parameter relating to the color.

### <Second Learning Process>

With reference to FIG. 10, the second learning process in S406 which the learning unit 304 performs is described. FIG. 10 is a flow chart illustrating an example of the flow of the second learning process in which the piece of captured image data in the learning unit 304 in accordance with Embodiment 1 is the piece of ground truth data. The processes in the flow chart illustrated in FIG. 10 are performed after the process in S405 illustrated in FIG. 4. After S405, in S1002, the learning unit 304 selects any piece of captured image data of the plurality of pieces of captured image data obtained in S402. The piece of captured image data selected in S1002 is used as a piece of ground truth data in the second learning process in a process in S1005 described below. Next, in S1003, the learning unit 304 obtains information (ray information) on a ray corresponding to each pixel of the captured image based on the camera parameter of the image capturing apparatus 101 which captures the captured image selected in S1002. The process in S1003 is the same process as the process in S803 illustrated in FIG. 8, and a detailed description thereof is omitted.

Next, in S1004, the learning unit 304 performs volume rendering relating to the three-dimensional field learning model in the middle of the learning based on the ray information obtained in S1003. Each pixel value in the virtual viewpoint image corresponding to appearance from a start point of the ray indicated by the ray information is thereby calculated. The process in S1004 is the same process as the process in S804 illustrated in FIG. 8, and a detailed description thereof is omitted. Subsequently, in S1005, the learning unit 304 calculates a difference between the value (pixel value) of each pixel in the virtual viewpoint image calculated in S1004 and the value (pixel value) of the pixel in the captured image corresponding to the pixel and updates the three-dimensional field learning model so that the difference becomes small. The process in S1005 is the same process as the process in S805 illustrated in FIG. 8, and a detailed description thereof is omitted.

Next, in S1006, the learning unit 304 judges whether all the pieces of captured image data are selected in S1002 or not. In a case where it is judged in S1006 that at least part of the pieces of captured image data are not selected, the first learning unit 304 returns to the process in S1002 and repeatedly performs the processes from S1002 to S1006 until it is judged in S1006 that all the pieces of captured image data are selected. In the repeated processes, in S1002, the learning unit 304 selects, for example, any piece of captured image data which has not been selected yet.

In a case where it is judged in S1006 that all the pieces of captured image data are selected, the learning unit 304 judges in S1007 whether an end condition relating to the second learning process is met or not. Specifically, for example, the learning unit 304 judges whether the end condition relating to the second learning process is met or not by judging whether the second learning has converged or not. For example, the learning unit 304 judges whether the second learning has converged or not by judging whether a loss value calculated by a loss function is equal to or less than a predetermined threshold value or not. Incidentally, a method for judging whether the end condition relating to the second learning process is met or not is not limited to what is mentioned above, but for example, whether or not the second learning process is performed for a predetermined period or the like may be judged.

In a case where it is judged in S1007 that the end condition relating to the second learning process is not met, the learning unit 304 returns to the process in S1002. After that, the learning unit 304 repeatedly performs the processes from S1002 to S1007 until it is judged in S1007 that the end condition relating to the second learning is met. In a case where it is judged in S1007 that the end condition relating to the second learning process is met, the learning unit 304 ends the processes in the flow chart illustrated in FIG. 10, namely, the process in S406 illustrated in FIG. 4.

As mentioned above, the image processing apparatus 102 is configured in such a way to perform the first learning in which the piece of low gloss image data generated based on the object area extracted from the captured image is the piece of ground truth data and perform the second learning in which the piece of captured image data is the piece of ground truth data by using the result of the first learning process. Specifically, the image processing apparatus 102 is configured in such a way as to initialize the parameter relating to the color and to inherit the parameter relating to the density in the result of the first learning process and to perform the second learning process. As a result of this, even in a case where the object 107 has a gloss characteristic on the surface, because of the first learning process, the density in the three-dimensional field relating to the object 107 can be estimated with high accuracy. Further, because of the second learning process inheriting the parameter relating to the density in the result of the first learning process, estimation accuracy of the density and the color in the three-dimensional field relating to the object 107 can be improved.

Incidentally, the effect of the learning can be enhanced by adjusting hyper-parameters set in the first learning process and the second learning process. For example, the degree of reliability of the result of the second learning process in which the piece of captured image data is the piece of ground truth data can be enhanced by setting a greater weight of a loss in the second learning process in S406 than that of a loss in the first learning process in S404. Consequently, the estimation accuracy of the color of the object 107 can be further improved.

### Embodiment 2

In Embodiment 1, an aspect in which the low gloss image is generated by setting predetermined pixel values for the object area and the non-object area extracted from each captured image, respectively is described. In Embodiment 2, an aspect in which the three-dimensional shape of the object 107 is estimated by using the object area extracted from the captured image and a low gloss image is generated based on the estimated three-dimensional shape and the pixel value of each captured image is described. A configuration of an image capturing system in accordance with Embodiment 2 and a hardware configuration and a functional configuration of the image processing apparatus 102 are the same as those illustrated in FIGS. 1 to 3, and thus detailed descriptions thereof are omitted. Hereinafter, only differences from Embodiment 1 are described. Further, an explanation is made by simply describing the image processing apparatus 102 in accordance with Embodiment 2 as “image processing apparatus 102.”

### <Operation of the Image Processing Apparatus>

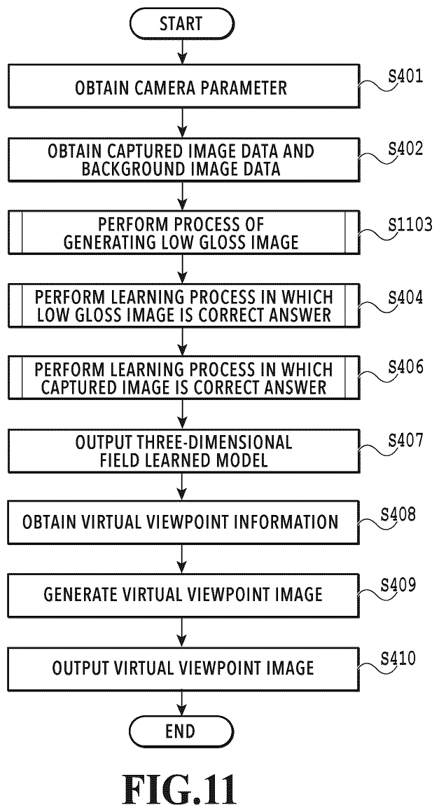

With reference to FIG. 11, the operation of the image processing apparatus 102 is described. FIG. 11 is a flow chart illustrating an example of a process flow in the image processing apparatus 102 in accordance with Embodiment 2. Incidentally, an identical reference numeral is assigned to a process identical to the process step illustrated in FIG. 4 in process steps illustrated in FIG. 11 and descriptions thereof are omitted. First, the image processing apparatus 102 sequentially performs the processes in S401 and S402.

After S402, in S1103, the first generation unit 303 performs a process of generating a low gloss image. Specifically, first, the first generation unit 303 estimates the three-dimensional shape of the object 107 by using the multi-viewpoint image, assigns a color to the estimated three-dimensional shape, and generates a piece of three-dimensional shape data indicating the colored three-dimensional shape of the object 107.

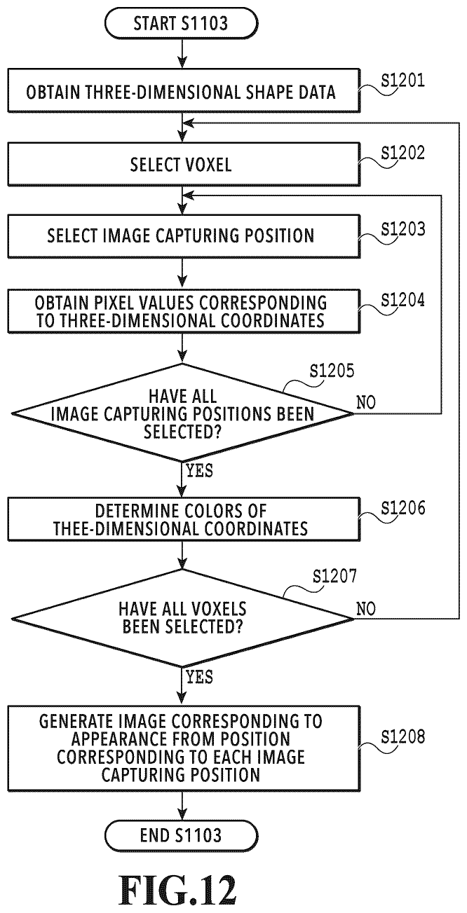

Next, the first generation unit 303 generates, as the low gloss image, a virtual viewpoint image corresponding to appearance in a case where the piece of three-dimensional shape data is viewed from a plurality of virtual viewpoints by using the piece of generated three-dimensional shape data. Details on the process of generating the low gloss image in S1103 are described below by using FIG. 12.

After S1103, the image processing apparatus 102 performs the process in S404, namely, the first learning process. After S404, the image processing apparatus 102 performs the process in S406, namely, the second learning process. After S406, the image processing apparatus 102 sequentially performs the processes from S407 to S410 and then ends the processes in the flow chart illustrated in FIG. 11. Incidentally, unlike Embodiment 1, the image processing apparatus 102 in accordance with Embodiment 2 does not perform the process in S405, that is, the image processing apparatus 102 does not initialize the parameter relating to the color of the three-dimensional field learning model which is obtained as a result of the first learning process in S404 after S404.

### <Process of Generating the Low Gloss Image>

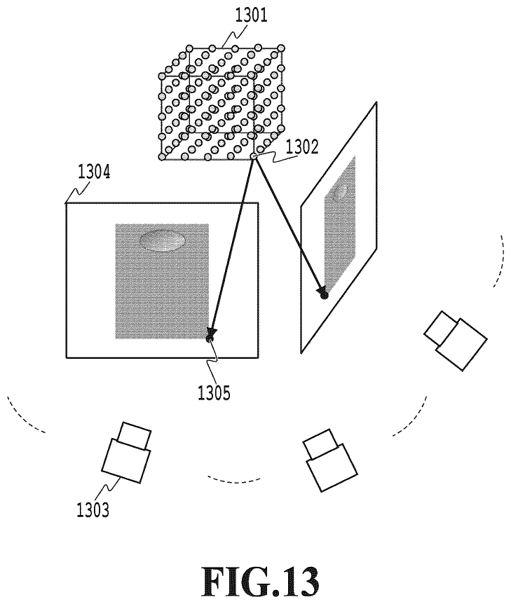

With reference to FIGS. 12 and 13, a process of generating the low gloss image in S1103 performed by the first generation unit 303 is described. FIG. 12 is a flow chart illustrating an example of the flow of the process of generating the low gloss image in the first generation unit 303 in accordance with Embodiment 2. FIG. 13 is a diagram to illustrate an example of a method for determining the pixel value of the low gloss image in the process of generating the low gloss image in accordance with Embodiment 2. The processes in the flow chart illustrated in FIG. 12 are performed after the process in S402 illustrated in FIG. 4. Incidentally, an identical reference numeral is assigned to a process identical to the process step illustrated in FIG. 5 in process steps illustrated in FIG. 12 and descriptions thereof are omitted.

First, in S1201, the first generation unit 303 estimates the three-dimensional shape of the object 107 based on the plurality of captured images and the background image corresponding to each captured image obtained in S402 and obtains the piece of three-dimensional shape data indicating the three-dimensional shape of the object 107. Specifically, for example, the first generation unit 303 first sequentially performs the processes of S501 to S503 and S505 illustrated in FIG. 5 and generates an object area map corresponding to each captured image. Next, the first generation unit 303 estimates the three-dimensional shape of the object 107 by a volume intersection method or the like by using the plurality of generated object area maps and a camera parameter corresponding to each object area map.

A method for estimating the three-dimensional shape of the object 107 is not limited to the volume intersection method. For example, the first generation unit 303 may estimate the three-dimensional shape of the object 107 by the following method. Specifically, first, on the assumption that a plurality of stereo cameras is composed of the plurality of image capturing apparatuses 101, the first generation unit 303 calculates distances from the plurality of image capturing apparatuses 101 to the object 107 by using the plurality of captured images and the camera parameter corresponding to each image. Next, the first generation unit 303 estimates the three-dimensional shape of the object 107 on the premise that the positions at the calculated distances are positions corresponding to the surface of the object 107.

The piece of three-dimensional shape data is a piece of point cloud data, a piece of polygon mesh data in which the surface shape of an object is represented by a plurality of polygons, or a piece of voxel data in which a voxel corresponding to the object is represented as an ON voxel and a voxel not corresponding to the object is represented as an OFF voxel, or the like. Hereinafter, an explanation is made on the premise that the first generation unit 303 obtains a piece of point cloud data 1301 as illustrated in FIG. 13 as an example as the piece of three-dimensional shape data indicating the three-dimensional shape of the object 107.

Next, in S1202, the first generation unit 303 selects any voxel 1302 of a plurality of voxels constituting the piece of three-dimensional shape data (point cloud data 801) obtained in S1201. Then, in S1203, the first generation unit 303 selects any image capturing position 1303 of the positions of the plurality of image capturing apparatus (image capturing positions). Subsequently, in S1204, the first generation unit 303 obtains a pixel value corresponding to the three-dimensional coordinates of the voxel 1302 selected in S1202 based on the three-dimensional coordinates of the voxel 1302 selected in S1202 and the camera parameter corresponding to the captured position selected in S1203. Specifically, the first generation unit 303 obtains the value (pixel value) of a pixel by projecting the three-dimensional coordinates of the voxel 1302 on a captured image 1304 and specifying a pixel 1305 corresponding to the three-dimensional coordinates by using the camera parameter.

In a case where the three-dimensional coordinates of the voxel 1320 can be projected on the captured image and the value of the pixel 1305 corresponding to the three-dimensional coordinates can be obtained, the first generation unit 303 increments the value of a counter indicating the number of captured images which can be projected. In contrast, in a case where the three-dimensional coordinates of the voxel 1302 are projected outside the viewing angle of the captured image 1304 or cannot be projected on the captured image 1304 because the three-dimensional coordinates of the voxel 1302 are occluded by the other objects or the like, the increment of the counter is skipped because the pixel value cannot be obtained.

After S1204, in S1205, the first generation unit 303 judges whether all the image capturing positions are selected in S1203 or not. In a case where it is judged in S1205 that at least part of the image capturing positions are not selected, the first generation unit 303 returns to the process in S1203 and repeatedly performs the processes from S1203 to S1205 until it is judged in S1205 that all the image capturing positions are selected. In the repeated processes, the first generation unit 303 in S1203 selects, for example, any image capturing position which has not been selected yet.

In case where it is in S1205 judged that all the image capturing positions are selected, in S1206, the first generation unit 303 determines the color of the three-dimensional coordinates of the voxel 1302 selected in S1202. Specifically, the first generation unit 303 calculates the average value of a plurality of pixel values corresponding to the three-dimensional coordinates of the voxel 1302 based on all the pixel values and the value of the counter obtained in S1204 and determines the calculated average value as the color value of the three-dimensional coordinates of the voxel 1302. The color value determined in S1206 is associated with the three-dimensional coordinates of the voxel 1302 and is added to the piece of three-dimensional shape data (point cloud data 1301) obtained in S1201. Incidentally, in the present embodiment, an explanation is made based on the premise that the average value of the plurality of pixel values corresponding to the three-dimensional coordinates of the voxel 1302 is determined as the color value of the three-dimensional coordinates of the voxel 1302, but a method for determining the color value of the three-dimensional coordinates of the voxel 1302 is not limited to this. For example, the first generation unit 303 may determine a predetermined statistical value such as a maximum value, a minimum value, a median, or a modal value of the plurality of pixel values corresponding to the three-dimensional coordinates of the voxel 1302 as the color value of the three-dimensional coordinates of the voxel 1302.

After S1206, in S1207, the first generation unit 303 judges whether all the voxels constituting the piece of point cloud data 801 are selected in S1202 or not. In a case where it is judged in S1207 that at least part of the voxels are not selected, the first generation unit 303 returns to S1202 and repeatedly performs the processes from S1202 to S1207 until it is judged in S1207 that all the voxels are selected. In a case where it is judged in S1207 that all the voxels are selected, in S1208, the first generation unit 303 performs the following image generation process. Specifically, the first generation unit 303 generates an image corresponding to appearance from a position corresponding to each image capturing position by performing rendering on the piece of three-dimensional shape data (point cloud data 1301) to which the color value has been added based on the camera parameter corresponding to each image capturing position. The image generated in S1208 is a low gloss image generated by the generation process in the first generation unit 303. After S1208, the first generation unit 303 ends the processes in the flow chart illustrated in FIG. 12, that is, the process in S1103 illustrated in FIG. 11.

As mentioned above, the color of the three-dimensional coordinates of each voxel constituting the piece of three-dimensional shape data indicating the three-dimensional shape of the object 107 is uniquely determined based on the captured image. Therefore, respective pixel values corresponding to identical three-dimensional coordinates in a plurality of low gloss images generated by using the piece of three-dimensional shape data are the same value. As a result, the density in the three-dimensional field relating to the object 107 estimated by the first learning process in which such a piece of low gloss image data is a piece of ground truth data is highly accurate.

Further, the pixel value of the low gloss image generated by the process of generating the low gloss image mentioned above is determined by using a plurality of captured images. Consequently, the color of the three-dimensional field relating to the object 107 estimated by the first learning process in which such a piece of low gloss image data is the piece of ground truth data cannot be said to be correct, but compared with a case of Embodiment 1, the color is highly accurate. Therefore, in the present embodiment, in relation to the three-dimensional field learning model which is obtained as a result of the first learning process in S404, the parameter relating to the color is not initialized and is continuously used for the second learning process in S406.

In the present embodiment, an explanation has been made on the premise that the piece of three-dimensional shape data is obtained based on the plurality of captured images and the low gloss image corresponding to the image capturing viewpoint is generated by using the piece of three-dimensional shape data, but the low gloss image is not limited to an image corresponding to appearance from the image capturing viewpoint. For example, the first generation unit 303 may set a plurality of virtual viewpoints different from the image capturing viewpoint, project the three-dimensional coordinates of each voxel constituting the piece of three-dimensional shape data obtained in S1201 on the virtual viewpoint, and generate the low gloss image corresponding to appearance from the virtual viewpoint. For example, the first learning process using the low gloss image corresponding to the virtual viewpoint is added by setting the virtual viewpoint mentioned above in addition to the image capturing viewpoint, and the estimation accuracy of the density in the sampling point may be thereby improved.

As mentioned above, the image processing apparatus 102 is configured in such a way as to generate the low gloss image by determining the pixel value of the object area in the low gloss image based on the pixel value of the captured image. According to such an image processing apparatus 102, not only the estimation accuracy relating to the density in the three-dimensional field relating to the object 107 but also the estimation accuracy relating to the color can be improved by performing the first learning process by using such a piece of low gloss image data as a piece of correct data.

Incidentally, in the present embodiment, performing the second learning process after the first learning process is described, but the order of learning processes performed on the three-dimensional field learning model is not limited to this. The learning processes performed on the three-dimensional field learning model may be performed, for example, by freely mixing part of the first learning process and part of the second learning process in order.

### Embodiment 3

In Embodiments 1 and 2, aspects in which the sampling point is set on the ray in an entire learning space as in the first learning process in the setting of the sampling point in the second learning process are described. In Embodiment 3, an aspect in which a setting range of a sampling point in a learning space in a case where the second learning process is performed based on the estimation value of the density in the three-dimensional field relating to the object which is obtained as a result of the first learning processing is provided is described. Incidentally, a configuration of an image capturing system in accordance with Embodiment 3 and a hardware configuration and a functional configuration of the image processing apparatus 102 are the same as those illustrated in FIGS. 1 to 3, and thus a detailed description is omitted, and only a difference between Embodiment 3 and Embodiment 1 or 2 is described. Further, hereinafter, an explanation is made by simply describing the image processing apparatus 102 in accordance with Embodiment 3 as “image processing apparatus 102.”

### <Operation of the Image Processing Apparatus>

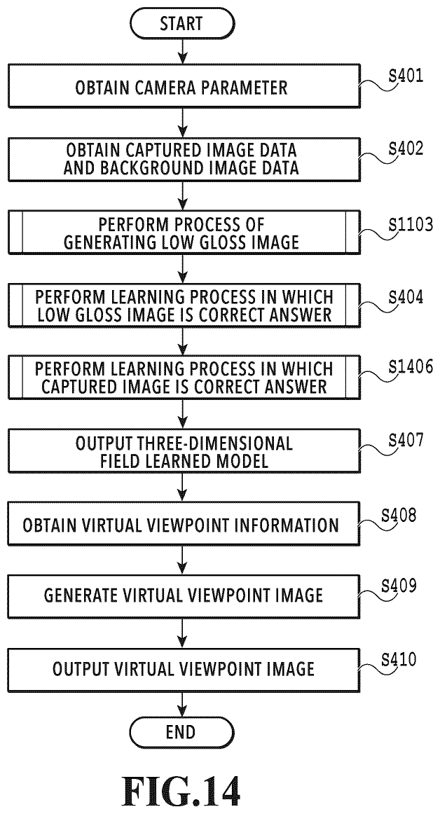

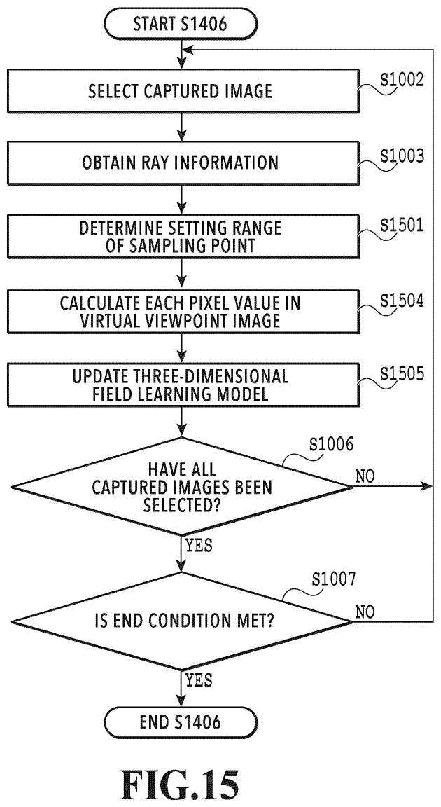

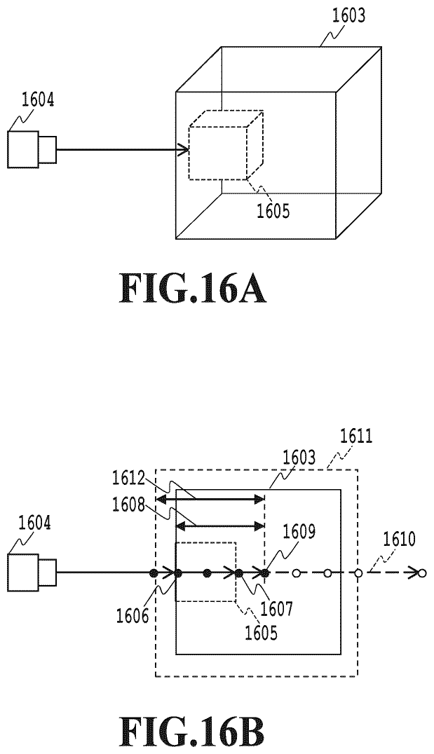

With reference to FIGS. 14 to 16B, the operation of the image processing apparatus 102 in accordance with Embodiment 3 is described. FIG. 14 is a flow chart illustrating an example of a process flow in the image processing apparatus 102 in accordance with Embodiment 3. Incidentally, in process steps illustrated in FIG. 14, an identical reference numeral is assigned to a process identical to the process step illustrated in FIG. 4 or 11 and descriptions thereof are omitted. First, the image processing apparatus 102 sequentially performs the processes in S401, S402, S1103, and S404. After S404, in S1406, the learning unit 304 performs the second learning process in which the piece of captured image data obtained in S402 is the piece of ground truth data. Details on the second learning process in S1406 are described below by using FIGS. 15 to 16B. After S1406, the image processing apparatus 102 sequentially performs the processes from S407 to S410 and ends the processes in the flow chart illustrated in FIG. 14 after S410.

### <Second Learning Process>

With reference to FIGS. 15 to 16B, the second learning process in S1406 performed by the learning unit 304 is described. FIG. 15 is a flow chart illustrating an example of the flow of the second learning process in which a piece of captured image data in the learning unit 304 in accordance with Embodiment 3 is a piece of ground truth data. The processes in the flow chart illustrated in FIG. 15 are performed after the process in S404 illustrated in FIG. 14. Incidentally, an identical reference numeral is assigned to a process identical to the process step illustrated in FIG. 10 in the process steps illustrated in FIG. 15 and descriptions thereof are omitted. After S404, the learning unit 304 sequentially performs the processes in S1002 and S1003. After S1003, in S1501, the learning unit 304 determines a setting range of a sampling point in the learning space based on information on the density in the three-dimensional field relating to the object 107 obtained as a result of the first learning process in S404. Specifically, for a plurality of rays indicated by the ray information obtained in S1003, the learning unit 304 determines a range to set a sampling point for each ray (setting range).

FIGS. 16A and 16B are diagrams to describe an example of a method for determining the setting range of the sampling point in the learning space in the learning unit 304 in accordance with Embodiment 3 and a method for setting the sampling point. FIG. 16A is a diagram illustrating an example of the positional relationship between an image capturing apparatus 1604 and an object 1603. An explanation is made as an example on the premise that the object 1603 illustrated in FIG. 16A has an indentation 1605 indicated by a broken line on a surface opposite the image capturing apparatus 1604. Further, an arrow indicated by a solid line extending from the image capturing apparatus 1604 used as a start point in a direction in which the object 1603 exists indicates the direction of an optical axis of the image capturing apparatus 1604.

FIG. 16B is a diagram in a case where the object 1603 indicated in FIG. 16A is horizontally viewed from a direction orthogonal to the optical axis of the image capturing apparatus 1604. Specifically, FIG. 16B illustrates an example of a sampling point set on a ray 1610 corresponding to the optical axis of the image capturing apparatus 1604 in a learning space 1611. Incidentally, in FIG. 16B, an example of a point set as the sampling point is represented as a black point on the ray 1610, and an example of a point not set as a sampling point is represented as a middle white circle on the ray 1610. In the present embodiment, an allowable error range 1608 of a distance between the position 1606 of the surface of the object 1603 indicated by the three-dimensional field relating to the object 1603 estimated in S404 and the position 1607 of the surface of the actual object 1603 is predetermined. The learning unit 304 determines a setting range 1612 of the sampling point in the learning space 1611 based on the allowable error range 1608.

After S1501, in S1504, the learning unit 304 performs volume rendering relating to a three-dimensional field learning model in the middle of learning based on the ray information obtained in S1003 and the information indicating the setting range determined in S1501. Each pixel value in the virtual viewpoint image corresponding to appearance from the start point of a ray indicated by the ray information is thereby calculated. Specifically, the learning unit 304 first sets a plurality of sampling points for each ray in the setting range of the sampling point corresponding to the ray on the ray indicated by the ray information. Next, the learning unit 304 performs volume rendering by accumulating colors estimated in the plurality of sampling points set on each ray according to estimated density. The process in S1504 is the same as the process in S1004 except for the process of setting the sampling points.

Next, in S1505, the learning unit 304 calculates a difference between the value (pixel value) of each pixel in the virtual viewpoint image calculated in S1005 and the value (pixel value) of a pixel in the captured image corresponding to the pixel and updates the three-dimensional field learning model so that the difference is small. Specifically, the learning unit 304 updates the three-dimensional field learning model so that the cumulative value of the densities of the sampling points set in the setting range is 1 for each ray. After S1505, the learning unit 304 performs the processes in S1006 and S1007 as appropriate and ends the processes in the flow chart illustrated in FIG. 15, that is, the process in S1406.

As in the above, the image processing apparatus 102 is configured in such a way as to determine the setting range of the sampling points in the second learning processing using the captured image based on the result of the estimation of the density in the three-dimensional field relating to the object with the low gloss image. Further, the image processing unit 102 is configured in such a way as to limit a cumulative range of the density in the second learning process by setting the sampling points in the setting range. According to the image processing unit 102 which is configured in this way, the robustness of the estimation value of the density in the three-dimensional field relating to the object can be improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the three-dimensional field relating to the object can be estimated with high accuracy even in a case where the object has the gloss characteristic on the surface.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-92979, filed on Jun. 7, 2024, which is hereby incorporated by reference wherein in its entirety.

What is claimed is:

1. An image processing apparatus comprising:
one or more hardware processors; and
one or more memories storing one or more programs configured to be executed by the one or more hardware processors, the one or more programs including instructions for:
obtaining a plurality of captured images which is obtained by capturing an object from each of a plurality of image capturing viewpoints;
obtaining a camera parameter corresponding to image capturing from each of the plurality of image capturing viewpoints;
generating a plurality of low gloss images in which a gloss component of the object is reduced based on the plurality of captured images; and
performing learning of a learning model indicating a three-dimensional field relating to the object by using the plurality of low gloss images and the plurality of captured images and the camera parameter.

2. The image processing apparatus according to claim 1, wherein the one or more programs further include instructions for:
generating the plurality of low gloss images so that a value of a pixel corresponding to an identical position in the object in each of the plurality of low gloss images is identical.

3. The image processing apparatus according to claim 2, wherein the one or more programs further include instructions for:
extracting an object area corresponding to a representation of the object from each of the plurality of captured images; and
generating the plurality of low gloss images by adding a color which does not depend on the plurality of captured images to an image area corresponding to the object area in each of the plurality of low gloss images.

4. The image processing apparatus according to claim 2, wherein the one or more programs further include instructions for:
estimating a three-dimensional shape of the object based on the plurality of captured images;
with respect to each of a plurality of three-dimensional coordinates included in the three-dimensional shape, determining a statistical value of a value of a pixel corresponding to the three-dimensional coordinates in the plurality of captured images as a color value of the three-dimensional coordinates; and
generating the plurality of low gloss images by projecting the three-dimensional shape on each of a plurality of arbitrary viewpoints.

5. The image processing apparatus according to claim 4, wherein
the plurality of arbitrary viewpoints includes at least one or more image capturing viewpoints of the plurality of image capturing viewpoints.

6. The image processing apparatus according to claim 4, wherein
the plurality of arbitrary viewpoints includes at least one or more arbitrary viewpoints different from the plurality of image capturing viewpoints and wherein the one or more programs further include instructions for:
performing learning of the learning model by using an arbitrary viewpoint camera parameter corresponding to the arbitrary viewpoints in a case of learning using a low gloss image generated by projecting the three-dimensional shape on the arbitrary viewpoint.

7. The image processing apparatus according to claim 1, wherein the one or more programs further include instructions for:
performing the learning by mixing learning using the plurality of low gloss images and learning using the plurality of captured images.

8. The image processing apparatus according to claim 1, wherein the one or more programs further include instructions for:
performing learning using the plurality of captured images after performing learning using the plurality of low gloss images.

9. The image processing apparatus according to claim 1, wherein the one or more programs further include instructions for:
performing learning of information on density and a color in a three-dimensional field relating to the object by performing learning of the learning model using the plurality of captured images after initializing information on the color of information on the density and the color in the three-dimensional field relating to the object in the learning model after the learning using the plurality of low gloss images is performed.

10. The image processing apparatus according to claim 1, wherein the one or more programs further include instructions for:
performing the learning of the learning model so that a weight of optimization in the learning using the plurality of captured images is heavier than in the learning using the plurality of low gloss images.

11. The image processing apparatus according to claim 1, wherein the one or more programs further include instructions for:
setting a learning condition based on information on density in the three-dimensional field relating to the object obtained as a result of learning using the plurality of low gloss images in the learning using the plurality of captured images; and
performing learning of information on density and a color in the three-dimensional field relating to the object by performing learning of the learning model using the plurality of captured images based on the learning condition.

12. An image processing method comprising the steps of:
obtaining a plurality of captured images which is obtained by capturing an object from each of a plurality of image capturing viewpoints;
obtaining a camera parameter corresponding to image capturing from each of the plurality of image capturing viewpoints;
generating a plurality of low gloss images in which a gloss component of the object is reduced based on the plurality of captured images; and
performing learning of a learning model indicating a three-dimensional field relating to the object by using the plurality of low gloss images and the plurality of captured images and the camera parameter.

13. A non-transitory computer readable storage medium storing a program for causing a computer to perform a control method of controlling an image processing apparatus, the control method comprising the steps of:
obtaining a plurality of captured images which is obtained by capturing an object from each of a plurality of image capturing viewpoints;
obtaining a camera parameter corresponding to image capturing from each of the plurality of image capturing viewpoints;
generating a plurality of low gloss images in which a gloss component of the object is reduced based on the plurality of captured images; and
performing learning of a learning model indicating a three-dimensional field relating to the object by using the plurality of low gloss images and the plurality of captured images and the camera parameter.
